(19) United States
(12) Patent Application Publication
(10) Pub. No.: US 2011/0063120 A1
(43) Pub. Date: Mar. 17, 2011

(54) MOTORCYCLE GRIPS WITH PRESSURE SENSORS AND ALARM SYSTEM

(76) Inventor: Ronnie Ebner, Lakewood, CA (US)

(21) Appl. No.: 12/560,023

(22) Filed: Sep. 15, 2009

(51) Int. Cl. G08B 21/00

(52) U.S. Cl. 340/665

(57) ABSTRACT

A pressure sensitive alarm system for solving the problem of arm pump commonly experienced by competitive motocross riders is provided. The system comprises motorcycle grips which incorporate one or more pressure sensors. The pressure sensors provide a signal to a control unit which compares the magnitude of the pressure sensor signal to a predetermined threshold value. When the predetermined threshold value is exceeded the control unit activates an alarm and maintains the alarm until the rider's grip pressure falls below the predetermined threshold value. The predetermined threshold value is a pressure magnitude which when exceeded by a rider is likely to lead the onset of arm pump. Means are provided for individually tailoring the predetermined threshold value to the specific needs of an individual rider.

### TECHNICAL FIELD

The present invention relates generally to the problem of chronic exertional compartment syndrome or arm pump in the forearms of motocross riders, and in particular to a system for warning motocross riders of when they are gripping the handlebars with excessive force.

### BACKGROUND ART

Motocross is a form of motorcycle racing involving high performance off-road motorcycles which are raced on artificially made dirt tracks. The tracks typically include steep jumps and obstacles and the races typically involve high speeds. Motocross racing is very demanding physically because racers must maintain complete control of their typically 200 or more pound bikes while maintaining top speed throughout the race. Motocross racing puts exceptional demands on a racer's forearms because the hands and forearms are the primary means of controlling the bike.

Chronic exertional compartment syndrome or arm pump occurs in a substantial number of motocross riders because essentially, while riding, the riders grip the handlebars so hard that over time they lose feeling and strength in their forearms. The condition has affected motocross competitors regardless of age or sex and varies in severity from annoying to dangerous. In extreme cases, a rider may lose control of his or her bike. The condition of arm pump is believed to occur because muscles (and forearm muscles in particular) are wrapped in inelastic sheaths of fascia. As the forearm muscles are worked during riding, they tend to expand against the inelastic fascia. This expansion of muscle tissue against the inelastic fascia in turn causes blood vessels to become compressed leading to a loss of blood flow to the muscle tissue and concomitantly to a loss of muscle strength and feeling.

In more detail, the forearm has two main sets of muscles. Those on the back side of the arm (dorsal side) and those on the lower side (volar side). These muscles are wrapped in layers of fascia. Fascia is a thin, strong, white layer that wraps the muscles into compartments. The fascia is not elastic and will not stretch. The fascia exists to keep the muscles in tightly wrapped cords. Since fascia is not stretchy, any increase in volume of blood flow will lead to increased pressure in and around those muscles. As blood continues to flow into the forearms (as a result of tightly gripping, i.e. maintaining a “death grip” on, the handlebars) the muscles expand against the fascia and become quite hard as a result of this pressure. If the pressure in the fascial compartments rises high enough, blood vessels can collapse, which restricts or stops flow through that vessel. Veins, with their low pressure and thin walls, collapse sooner than high pressure thick walled arteries. When veinous flow reduces, arterial blood continues to enter the fascial compartment but is restricted from leaving. This restricted outflow further increases the pressure within the fascial compartment. If the compartment pressure rises higher than the arterial pressure, than the arteries as well may collapse resulting in near complete oxygen deprivation to the muscles.

Motocross riders are particularly susceptible to arm pump because blood flow in the forearms occurs only when the muscles are relaxed. During riding and particularly during competitive events, a motocross rider's arms do not tend to relax sufficiently to avoid arm pump. The problem of arm pump is so common and frequently severe that motocross riders have turned to numerous of means of relieving the problem. These means include a variety of exercises and stretches, devices designed to assist in performing specific exercises, and in many instances, surgery.

Prior art attempts to address the issue of arm pump have not been entirely successful. The various exercises that have been developed to address the problem appear to be misguided because the fundamental anatomical problem which causes arm pump is the inelasticity of the fascia surrounding the muscles. Therefore, attempts to make the forearm muscles stronger and thus more resistant to arm pump are doomed to failure because lack of strength is not the problem. Stretching exercises are likewise limited in the degree of relief that they can provide because while the muscles within their fascial wrappings may be stretched, the fascia itself is not particularly stretched and being an inelastic material is inherently resistant to stretching. Surgical approaches to the problem involve making selective incisions in the fascia for the purpose of allowing the forearm muscles to expand a greater amount than would otherwise be possible. The effectiveness of surgical solutions have so far proved inconclusive. Moreover, the long term consequences of making incisions in the fascia for the purpose of intentionally weakening the fascia are not well understood. The prior art solutions to relieve arm pump, though well intentioned fail to address the fundamental cause of the problem with is a rider's tendency to maintain too tight a grip on the handlebars.

It is the purpose of the present invention to provide a device that measures the pressure a motocross rider is exerting on the handle bar grips and to sound an alarm when the pressure exceeds a predetermined level sufficient to cause the onset of severe or debilitating arm pump.

### SUMMARY OF THE INVENTION

The present invention solves the problem of arm pump commonly experienced by motocross riders by providing an alarm system that is sensitive to the pressure the rider is exerting on the motorcycle's handlebar grips. The system comprises motorcycle grips which incorporate one or more pressure sensors. The pressure sensors provide a signal to a control unit which compares the magnitude of the pressure sensor signal to a predetermined threshold value. When the predetermined threshold value is exceeded the control unit activates an alarm and maintains the alarm until the rider's grip pressure falls below the predetermined threshold value. The predetermined threshold value is a pressure magnitude which when exceeded by a rider is likely to lead the onset of arm pump. The control unit may be equipped with a sensitivity control for increasing or decreasing the threshold value such that the predetermined threshold value may be tailored to the rider via a trial and error process. By using the system, the motocross rider may train himself to reduce his grip pressure and thereby avoid the frequently debilitating problem of arm pump.

### BRIEF DESCRIPTION OF THE DRAWINGS

FIG. 1 is a block diagram showing one example of the arrangement of components that can be used with grip mounted pressure sensor warning system of the present invention.

### DETAILED DESCRIPTION OF THE PREFERRED EMBODIMENTS

The present invention will now be described more fully hereinafter with reference to the accompanying drawings, in which preferred embodiments of the invention are shown. The invention may, however, may be embodied in many different forms and should not be construed as being limited to the embodiments set forth herein. Rather these embodiments are provided so that this disclosure will be thorough and complete, and will fully convey the scope of the invention to those skilled in the art. Like numbers refer to like elements throughout.

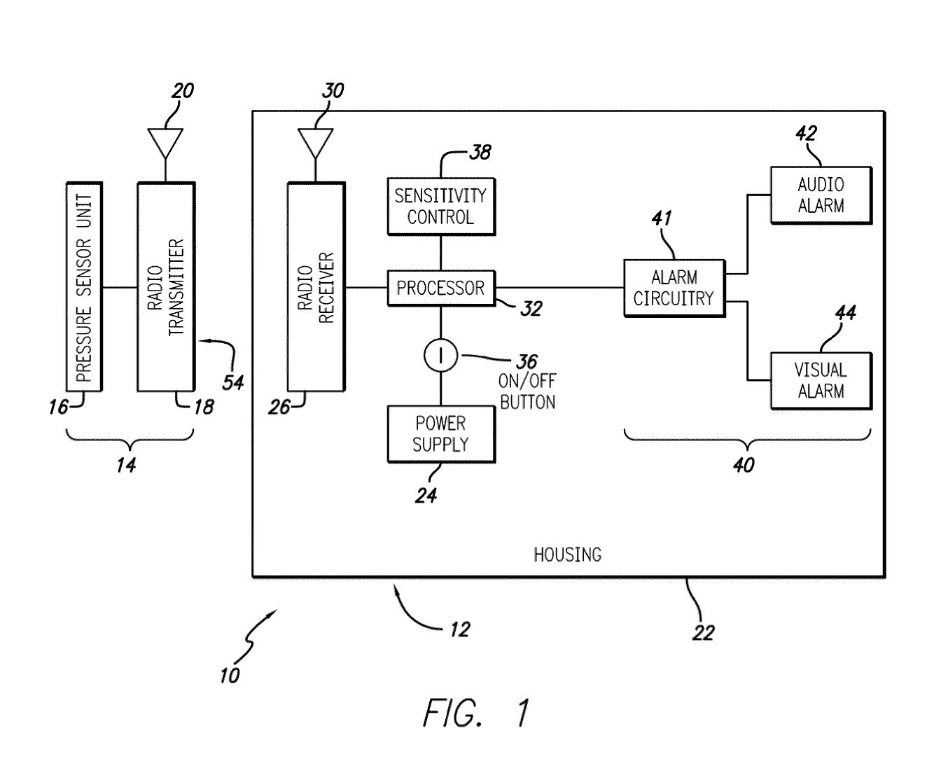

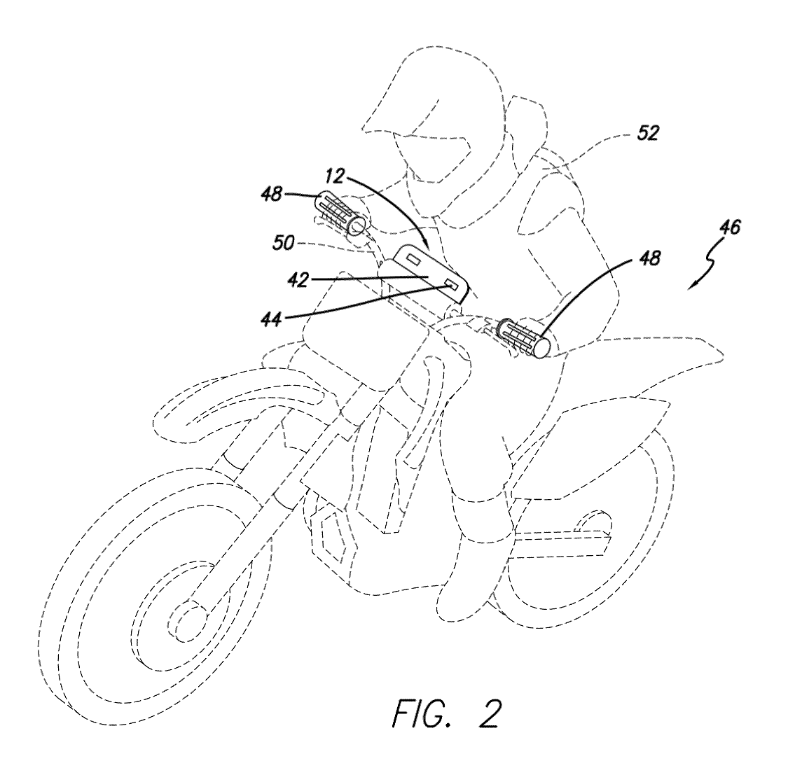

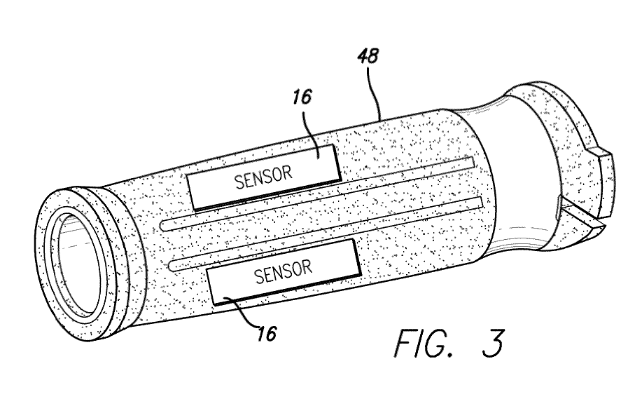

With reference to FIGS. 1 through 3, the present invention solves the problems of arm pump via an alarm system 10 that is sensitive to the pressure applied by a motocross rider 52 to the grips 48 of a motorcycle 46. The alarm system warns the motocross rider of when he is gripping the handlebars too tightly and thus provides the rider with a means of training himself to relax his arms while riding. The alarm system of the present invention comprises two main units, the control unit 12 and the pressure sensor unit 14.

The pressure sensor unit 14 includes one or more pressure sensors 16, and a means of transmitting a signal 54 from the pressure sensors to the control unit 12. Typically, the pressure sensors will be attached to or within the motorcycle grips 48 as shown in FIG. 3. The pressure sensors serve to monitor the motorcycle rider's hand pressure or griping force exerted by gripping the handlebars 50 while riding. The ability of the sensor equipped grips 48 to accurately monitor a rider's grip pressure will improve as the number of sensors placed radially about the perimeter of the grip 48 increases. Measurement of grip pressure can be further refined by placing additional rows of sensors longitudinally in the grips. The sensors may vary in number from as few as one to a dozen or more. The number of sensors used may be increased as necessary to achieve the desired accuracy in pressure monitoring. Several types and brands of commercially available pressure sensors are suitable for use in the invention. Pressure sensors manufactured by Silicon Microstructures, Inc., 1701 McCarthy Blvd., Milpitas, Calif. 95035, part nos. SM5102, SM5103, SM5106, SM5108 and SM5112 are examples of such suitable pressure sensors.

Several means 54 are possible for transmitting signals from the pressure sensors 16 to the control unit 12. In the embodiment shown in FIG. 1, the means for transmitting the sensor(s) signal comprises a radio frequency transmitter 18 and an antenna 20. Other means of transmitting the signal include electrically connecting the control unit and the pressure sensors via simple wires. In the case of the grip 48 that covers the motorcycle's rotary throttle mechanism, a brush or slip-ring arrangement could be used to make the electrical connection. Other means of having the sensors communicate with the control unit 12 are also possible and are known in the art.

The control unit 12 includes a means for receiving a signal 28 from the pressure sensor unit 14, a comparator 32 means for comparing the signal to a predetermined threshold level and operating an alarm 40 if the signal exceeds the predetermined threshold level. In the embodiment shown in FIG. 1, the control unit further comprises a sensitivity control 38 for adjusting the predetermined threshold value and the alarm 40 includes both audio 42 and visual 44 alarms. Typically, the control unit will also be equipped with an on/off switch or power on/off button 36. The control unit will also typically include a power supply 20 and the component parts will be wholly or partially contained within a housing 22.

In the embodiment shown in FIG. 1, the means for receiving a signal 28 from the pressure sensor unit 14 includes a radio frequency receiver 26 and an antenna 30. Alternatively, the means for receiving a signal 28 could also be simple wires for making an electrical connection between the control unit 12 and the pressure sensor unit 14.

The comparator means 32 may be a microprocessor programmed as follows: The comparator means 32 compares the magnitude of the incoming pressure sensor unit 14 signal to the predetermined threshold value and activates the alarm 40 when the magnitude of the pressure sensor unit 14 signal exceeds the predetermined threshold value. The comparator means maintains the alarm in an on condition, i.e. keeps the alarm activated, until such time as the pressure sensor unit 14 signal falls below the predetermined threshold value. That is, whenever the magnitude of the pressure sensor unit's 14 signal exceeds the threshold value, the comparator means 32 activates the alarm 40 and maintains the alarm until such time as the magnitude of the pressure sensor unit 14 falls below the threshold value.

As an alternative to a microprocessor, a dedicated electrical circuit may used to achieve the same purpose. The selection and programming of microprocessors and the design of dedicated electronic circuits to serve the function of the comparator means 32 of the present invention are well known to those skilled in the electronic arts. Likewise, those skilled in electronic arts are readily well familiar with the design of circuits suitable for the pressure sensor unit 14 and with the related circuitry required to allow the pressure sensor unit and the alarm 40 to communicate with the comparator means 32.

The sensitivity control 38 may be a potentiometer or other device suitable for varying the predetermined threshold valued. The sensitivity control 38 electrically communicates with comparator means 32 and may be incorporated as part of the comparator means electrical circuit. The alarm 40 may be either an audio alarm 42 or a visual alarm 44 or both. The audio alarm will typically be a speaker or other device capable of reproducing audible sounds. The visual alarm may be any light emitting device such as a LED, light bulb, electronic screen and the like.

In the embodiment of the invention shown in FIG. 1, the audio and visual alarms 42 and 44 are shown diagrammatically as being part of the control unit 12. However, alternative embodiments are possible and may be desirable. For instance, the alarms could be located remotely from the control unit 12 on the motorcycle handlebars 50 or in some other location readily monitored by the rider. The signals to operate the alarms could be transmitted by the control unit on dedicated short range radio frequencies. Likewise, some motorcycle helmets include am/fm radios and/or radios for the purpose of communicating with the rider's race team and/or race track officials. Therefore, the control unit 12 rather than incorporating a speaker as the audio alarm 42 could instead include a transmitter which would transmit an alarm signal to the rider's helmet radio. Likewise, motorcycle helmets in the future may include “heads up” displays such as are now available on some luxury cars. Therefore, the visual alarm 44 rather than being a lamp or screen may be a radio signal transmitted to a heads up display which would then generate a visual alarm signal. In yet other embodiments, helmets may include dedicated audio and visual alarms that are activated via radio signals transmitted from the control unit 12. All of these embodiments (and their equivalents) as described herein fall within the spirit and scope of the claims of the present invention.

The power supply 24 of the present invention may be a self contained power supply, i.e. batteries, or alternatively, the power supply may receive electrical power from the motorcycle's electrical system and convert it to a voltage and amperage level suitable to power the control unit 12. It is also possible that the control unit 12 may be designed to operate directly at the voltage supplied by the motorcycle's electrical system and in that instance, the power supply 24 would not be needed.

The housing 22 of the invention may be of any size or shape suitable for enclosing in whole or in part the component parts of the control system 12. The materials used to construct the housing may comprise metals or plastics. Other materials are also suitable. Embodiments of the invention that do not include a housing discrete from the motorcycle are also possible.

The control unit 12 may be located at any convenient place on the motorcycle as dictated by factors such as whether the alarm 40 will be configured integrally with the control unit or will be remotely located from the control unit. It may also be desirable to incorporate the pressure sensor unit 14, control unit 12 and alarm 40 entirely within a motorcycle grip.

### OPERATION OF THE INVENTION

The arm pump alarm system 10 operates as follows. A rider activates the system via the switch 38. From thereon, the system monitors the rider's grip pressure. The pressure sensor unit 14 monitors the rider's grip pressure and transmits a signal representing the magnitude of that pressure to the control unit 12. The comparator means 32 of the control unit compares the pressure sensor signal to a predetermined threshold value and if the signal exceeds the threshold value, the processor actuates the alarm 40 which may include both audio 42 and visual 44 alarms. The comparator means keeps the alarm(s) activated until such time as the magnitude of the signal from the pressure sensor unit falls below the predetermined threshold value.

One issue that arises is how to set the threshold value for activating the alarm 40 as the forearm physiology of each individual rider and hence the sensitivity of the rider to arm pump will be different. That is, some riders because of their specific physiology will tend to be less sensitive to arm pump than others. Likewise, some riders will tend to be more sensitive to arm pump. For this reason, the control unit 12 is equipped with the sensitivity control 38 that has the ability to raise or lower the threshold value at which the alarm 40 is triggered. By using the sensitivity control, each individual rider will be able to determine an appropriate threshold level or value for triggering the alarm 40 through the process of trial and error. More particularly, a rider may determine his or her appropriate threshold level by beginning riding with the threshold value set via the sensitivity control at a median value. If during riding, the rider experiences arm pump without the alarm having activated, the rider may adjust the sensitivity control such that the alarm activates at a lower grip pressure. Likewise, if the alarm activates but the rider is not experiencing arm pump, the rider may adjust the sensitivity control so as to activate the alarm only upon reaching a higher level of grip pressure.

Once the desired or threshold level which indicates the onset of excessive arm pump has been determined, thereafter the rider uses the arm pump alarm as a training device which teaches him to relax his grip on the motorcycle. That is, when the alarm sounds or lights, the rider relaxes his grip until the alarm stops. If during the course of riding the alarm again activates, the rider relaxes his grip until the alarm stops. In this manner, the rider may train himself to ride in a relaxed manner and avoid severe and dangerous arm pump.

The foregoing detailed description and appended drawings are intended as a description of the presently preferred embodiment of the invention and are not intended to represent the only forms in which the present invention may be constructed and/or utilized. Those skilled in the art will understand that modifications and alternative embodiments of the present invention which do not depart from the spirit and scope of the foregoing specification and drawings, and of the claims appended below are possible and practical. It is intended that the claims cover all such modifications and alternative embodiments.

1. An alarm system sensitive to pressure comprising:
pressure sensor means for sensing the pressure applied to at least one motorcycle grip and generating a representative signal; and
control means for comparing the magnitude of the signal from the sensor means to a predetermined threshold value, wherein the control means activates an alarm when the magnitude of the signal from the sensor means exceeds the predetermined threshold value.

2. The alarm system of claim 1 wherein the control means further maintains the alarm in an on condition for so long as the magnitude of the signal from the pressure sensor means remains above the predetermined threshold value.

3. The alarm system of claim 1 wherein the pressure sensor means is remotely located from the control means and the representative signal from the pressure sensor means is communicated to the control means via radio frequency signals.

4. The alarm system of claim 1 wherein the alarm is remotely located from the control means and the control means communicates with the alarm via radio frequency signals.

5. The alarm system of claim 1, further comprising a sensitivity control wherein the sensitively control can increase or decrease the predetermined threshold value.

6. The alarm system of claim 1 wherein the sensor means comprises at least one pressure sensor affixed to a motorcycle grip.

7. The alarm system of claim 1 wherein the sensor means comprises a plurality of pressure sensors equally spaced radially about a longitudinal axis of a motorcycle grip.

8. The alarm system of claim 1 wherein the alarm includes an audio alarm and a visual alarm.

9. An alarm system sensitive to pressure comprising:
pressure sensor means for sensing the pressure applied to at least one motorcycle grip and generating a representative signal;
control means for comparing the magnitude of the signal from the sensor means to a predetermined threshold value, wherein the control means activates an alarm when the magnitude of the signal from the sensor means exceeds the predetermined threshold value; and
a sensitivity control wherein the sensitively control can increase or decrease the predetermined threshold value.

10. The alarm system of claim 9 wherein the control means further maintains the alarm in an on condition for so long as the magnitude of the signal from the pressure sensor means remains above the predetermined threshold value.

11. The alarm system of claim 9 wherein the pressure sensor means is remotely located from the control means and the representative signal from the pressure sensor means is communicated to the control means via radio frequency signals.

12. The alarm system of claim 9 wherein the alarm is remotely located from the control means and the control means communicates with the alarm via radio frequency signals.

13. The alarm system of claim 9 wherein the sensor means comprises at least one pressure sensor affixed to a motorcycle grip.

14. The alarm system of claim 9 wherein the sensor means comprises a plurality of pressure sensors equally spaced radially about a longitudinal axis of a motorcycle grip.

15. The alarm system of claim 9 wherein the alarm includes an audio alarm and a visual alarm.

16. An alarm system sensitive to pressure comprising:
pressure sensor means for sensing the pressure applied to at least one motorcycle grip and generating a representative signal;
control means for comparing the magnitude of the signal from the sensor means to a predetermined threshold value, wherein the control means activates an alarm when the magnitude of the signal from the sensor means exceeds the predetermined threshold value and further wherein the control means further maintains the alarm in an on condition for so long as the magnitude of the signal from the pressure sensor means remains above the predetermined threshold value; and
a sensitivity control wherein the sensitively control can increase or decrease the predetermined threshold value.

17. The alarm system of claim 16 wherein the pressure sensor means is remotely located from the control means and the representative signal from the pressure sensor means is communicated to the control means via radio frequency signals.

18. The alarm system of claim 16 wherein the alarm is remotely located from the control means and the control means communicates with the alarm via radio frequency signals.

19. The alarm system of claim 16 wherein the sensor means comprises at least one pressure sensor affixed to a motorcycle grip.

20. The alarm system of claim 16 wherein the sensor means comprises a plurality of pressure sensors equally spaced radially about a longitudinal axis of a motorcycle grip.
